(19) United States
(12) Patent Application Publication
(10) Pub. No.: US 2026/0012241 A1
(43) Pub. Date: Jan. 8, 2026

(54) METHOD AND APPARATUS OF DUPLICATED USER EQUIPMENT REPORT TRANSMISSION

(71) Applicant: Continental Automotive Technologies GmbH, Hannover (DE)

(72) Inventors: Hojin Kim, Regensburg (DE); Rikin Shah, Langen (DE); Reuben George Stephen, Singapore (SG); Andreas Andrae, Frankfurt am Main (DE); David Gonzalez Gonzalez, Egelsbach (DE)

(73) Assignee: Continental Automotive Technologies GmbH, Hannover (DE)

(21) Appl. No.: 19/100,607

(22) PCT Filed: Aug. 2, 2023
(86) PCT No.: PCT/EP2023/071450

§ 371 Date: Feb. 3, 2025

(30) Foreign Application Priority Data
Aug. 3, 2022 (DE) 10 2022 208 073.4

(51) Int. Cl. H04B 7/06; H04W 56/00; H04W 72/044; H04W 72/21; H04W 76/20

(52) U.S. Cl. CPC H04B 7/0632; H04W 56/0015; H04W 72/044; H04W 72/21; H04W 76/20

(57) ABSTRACT

A user equipment device, which is connected to a wireless communication network, transmits a duplicated user-equipment report. The user-equipment device determines radio channel quality conditions of the used beam or cell based on a measured Channel Quality Indicator and sends, if poor channel quality is determined, a duplication of a local-model-update report in a time-frequency domain A base station configures time-frequency resources in a dedicated manner with a Radio-Resource-Control-reconfiguration message and/or system information.

### CROSS-REFERENCE TO RELATED APPLICATIONS

The present application is a National Stage Application under 35 U.S.C. § 371 of International Patent Application No. PCT/EP2023/071450 filed on Aug. 2, 2023, and claims priority from German Patent Application No. 10 2022 208 073.4 filed on Aug. 3, 2022, in the German Patent and Trademark Office, the disclosures of which are herein incorporated by reference in their entireties.

### TECHNICAL FIELD

The application generally relates to wireless communications and, more particularly, to apparatuses and methods for improving reliability of uplink data e.g., local model update transmitted by mobile device in different Radio Resource Control (RRC) states.

### BACKGROUND

Because transitioning from a RRC inactive or RRC idle state to a RRC connected state might cause overheads for a User Equipment (UE) when only a small amount of data is to be transmitted, 3rd Generation Partnership Project (3GPP) has introduced technologies to optimize such small packets transmission. Indeed, UE needs to exchange multiple control signals to initiate and maintain a connection with a network. When payload size is relatively small compared with the amount of required control signals, establishing a connection becomes a concern for both the network and UE due to control signaling overhead.

Recently, AI/ML (Artificial Intelligence/Machine Learning) has been adopted as study item for 3GPP also started to work on its technical investigation to apply to multiple use cases for PHY/MAC (Physical Layer/Medium Access Control Layer) and higher layers of the OSI (Open Systems Interconnection) model of computer networking. Among AI/ML techniques, federated learning (FL) has been included in 3GPP AI/ML working list. In FL, AI/ML based local model updates are collected from multiple users (e.g., UE devices) and the global model on the server (e.g., gNodeB (gNB) as 3GPP-compliant implementation of the 5G-NR (New Radio) base station, i.e. the base station of the wireless communication) is updated in iterative way for model training/inference.

The RRC inactive state was introduced so as to keep the AS (Access Stratum) context at the base station and UE, with the aim of reducing energy consumption and the number of messages exchanged between a user equipment and a base station. The AS describes a functional layer between the radio network and user equipment. The AS is responsible for transporting data over the wireless connection and managing radio resources (data link layer).

However, in radio access network with gNB and UEs for federated learning UE can experience intra-/inter-cell mobility issue during AI/ML operation such as model training due to UE movement.

The 5G NR (New Radio) standard uses highly directional communication links using a large number of antenna elements and providing a large number of directional beams for communication. By using highly directional beam form, a gain is reached compensating for propagation losses. However, highly directional links require precise alignment of the beams at both the gNBs and the UEs. This requires an efficient management of beams, in particular in cases where the UEs and gNBs are moving relative to each other. Thus, it may be necessary to switch from one beam to another beam during communication between one gNB and one UE. This beam switching is called intra-cell mobility or beam-level mobility. On the other hand, inter-cell mobility describes a handover of the ongoing communication from one cell to another.

When there are mobile UEs going through intra-/inter-cell mobility, the overall global model performance in AI/ML operation can be degraded as those mobile UEs can be missed out and contribute to global model divergence.

Especially in case of beam-level mobility scenarios, mobile UEs providing in UE report transmissions local model updates to network side such as gNB (where global model is located) is significantly important to maintain maximum possible number of UEs participating in model training after being pre-selected. In AI/ML global model training with federated learning, UEs providing local model updates can move away from the determined beam direction with beam-level mobility or can be located at beam-edge, and those UEs can then be missed out due to poor link quality with the outdated beam direction.

Therefore, it is highly necessary to consider how to manage mobile UEs providing local model updates in UE report transmissions when they experience beam-level mobility.

5G NR (New Radio) beam management is known to retain an optimal beam pair for good connectivity. A beam pair comprises a transmit beam and a corresponding receive beam in one link. To this aim, UEs measure received signal power in both, RRC inactive state and RRC connected state. Such measurement is typically based on a detected beam strength. UEs report these measurements in preconfigured intervals to the gNB and receives from the gNB information for a new beam, once a new uplink was granted.

Prior art showed the contributions related to key areas of the selected taxonomy. The prior art contained various methods of ML based applications using federated learning for wireless communications. However, no solution is presented for explicit UE mobility scenarios. FIGS. 1 and 2 illustrate the stamen above for the defined problem, as later explained in more detail.

The intension of this application is to give a solution to this defined. Without managing those UEs carefully, the overall global model operation can be impacted with divergent performance by losing them for model training.

This invention gives a solution for this described problem accordingly with the method of claims 1 and/or 8 and the corresponding apparatus according to claims 6, 7 and/or 9, 10 and/or 11. A duplication of local model update report is proposed whereby each local model update report of/from or for UEs having poor channel quality in beam-level mobility or beam-edge region is duplicated and transmitted at different time interval over different frequency resources.

Beneficially the proposed idea can improve reliability of local model update report.

### BRIEF SUMMARY

In one aspect, it is proposed a method of duplicated user equipment (UE) report transmission by a user equipment device connected to a wireless communication network. An UE report transmission may be defined as a transmission of a local model update collected in an UE to network side having the global model for model training and/or interference of the global model, i.e. a transmission from the user equipment (UE) device. The location of global model may be a base station (gNB) of the wireless communication network or connected thereto.

The proposed method of or for user equipment (UE) report transmission by or from a user equipment (UE) device connected to a wireless communication network comprises that UE determines channel quality of the used beam or cell based on CQI measure, and, if it determines poor channel quality, then it sends a duplication (duplicate) of the local model update report in a time-frequency domain of the wireless communication where a base station (gNB) of the wireless communication network configures time-frequency resources in dedicated manner with RRC reconfiguration message and/or system information. Wireless communication such as 5G-NR (New Radio) are often operating in more frequency bands controlled by the base stations gNB. Determining poor channel quality means that the UE monitors beam reference signals (RS) exchanged in the wireless communication between UEs and gNB, and identifies a potential beam failure once predetermined failure trigger conditions are met. This is known to the skilled person, e.g. in the 5G NR communication as described in the 3GGP standard. Sending a duplication of the local model update report in a time-frequency domain of the wireless communication means that UE chooses another communication channel or beam in the wireless communication, which still is in the time-frequency domain of the wireless communication as configured by the base station gNB, i.e. the duplicated report is transmitted at a different time interval over different frequency resources, but still within time-frequency domain of the wireless communication.

The time-frequency domain actually used by the gNB is known to the UE from the RRC reconfiguration and/or system information messages regularly between UEs and gNB.

The CQI measure (Channel Quality Indicator) is well established and used in mobile or wireless telecommunications (such as LTE or 5G) by the UE to indicate the channel quality to the base station gNB. The CQI reported value is typically between 0 and 15. CQI is a feedback mechanism used by the user equipment (UE) to inform the serving base station (eNodeB) about the quality of the downlink channel. The CQI may be calculated at the UE based on the signal-to-noise ratio of the received common pilot. Instead of expressing the CQI as a received signal quality, the CQI is expressed as a recommended transport-block size, taking into account also the receiver performance. This technique is well known to the skilled person.

The proposed solution means that it is very likely that, if the original UE report transmission fails due to a beam-level mobility issue (based on the significant movement of the UE, the duplicated UE report transmission is received at the network side.

According to an advantageous embodiment of the proposed method, UE determines radio channel quality conditions based on a threshold configured by the base station gNB where said threshold is configured through a system information message for synchronization (SSB, Synchronization Signal Block) for idle mode and RRC reconfiguration message for channel state information (CSI-RS, channel state information reference signal) for connected mode. For example, this information is well defined for 5G NR communication and known to the skilled person.

The method may according to a advantageous proposal be characterized by that the user equipment (UE) device is configured to decide to duplicate a local model update transmission when the current channel quality is poor.

For avoiding any latency issue in reporting local model updates to the server containing the AI/ML global model, the base station (gNB) configures the CG-periodicity (configured grant), i.e. the configured scheduling (periodicity) for a data uplink from the user equipment (UE) device to the base station (gNB), very short. This avoids that model updates arrive with significant delay (latency), in particular if actual data for the global model is necessary. Very short means in particular, that the uplink periodicity is shorter than a usual communication process for every transmission initialized by the user equipment (UE) device, using e.g. downlink control information (DCI) comprising information to schedule (allocate physical resources) for downlink data (PDSCH) and information to schedule (allocate physical resources) for uplink Data (PUSCH).

According to a preferred proposal it may be provided that for local model update reporting as a channel a PUCCH-channel of the wireless communication network is used, if number of bits in local update report is small, i.e. contains only few payload data, and a PUSCH-channel of the wireless communication network is used, if local model update information could be large and part of RRC signaling, wherein the PUCCH-channel is a physical uplink control channel that carries uplink control information UCI and may be combined with moderate payload data and the PUSCH-channel is a physical uplink shared channel that carries user data and can be combined with uplink control information UCI. Communication using the PUCCH-channel uses less resources compared to communication using the PUSCH-channel and may thus be preferred for transmission of only view payload bits for local model update reporting.

The invention also relates to an apparatus of or for duplicated UE report transmission in a wireless communication network directed to a base station, the apparatus comprising a wireless transceiver(, a processor coupled with a memory in which computer program instructions (603) are stored, said computer program instructions being configured to implement steps of any of the claims 1 to 5 or parts thereof. According to a preferred embodiment, such apparatus (as defined in claim 6) may be comprised in an user equipment (UE) device. The user equipment (UE) device may be a mobile station, a wireless terminal, or the like, and for example any one of the following (the list not being exhaustive): a mobile or cellular phone or communication device, a wireless modem, a wireless communication device, a handheld device, a laptop computer, an IoT (internet of things) device, like wireless camera, a smart sensor or smart meter, a vehicle, a global positioning system device, or any other device configured to communicate through a wireless network.

In a preferred embodiment, the user equipment (UE) device may be a device adapted to move in road traffic applications or other applications with a relative high velocity relative to the base station of the wireless communication network, i.e. typically with a relative velocity faster than 20 km/h or even faster.

The invention also relates to a method of duplicated UE report transmission by a user equipment (UE) device connected to a wireless communication network, in particular according to or for use in a method as described before and/or related to any of claims 1 to 5, for receipt of the duplicated UE report transmission, as defined in claim 8. In the transmission, if UE determines poor channel quality of the used beam or cell based on a CQI measure, it then may send duplication of local model update report in time-frequency domain where the base station (gNB) configures time-frequency resources in dedicated manner with RRC reconfiguration message and/or system information.

The invention also relates to an apparatus of duplicated UE report transmission in a wireless communication network, the apparatus comprising a wireless transceiver, a processor coupled with a memory in which computer program instructions are stored, said computer program instructions being configured to implement steps of claim 8. According to a preferred embodiment, such apparatus (as defined in claim 9) may be comprised in a base station (gNB) of the wireless communication system.

The invention also relates to a wireless communication system for duplicated UE report transmission from a user equipment (UE) device to a base station, wherein the base station (gNB) comprises a processor coupled with a memory in which computer program instructions are stored, said computer program instructions being configured to implement steps of claim 8, wherein the user equipment (UE) device comprises a processor coupled with a memory in which computer program instructions are stored, said computer program instructions being configured to implement steps of claims 1 to 5.

In some embodiments, the various steps of the method for receiving Small Data Transmission by a user equipment and/or the method for sending Small Data Transmission by a base station are determined by instructions of computer programs.

Consequently, the disclosure further contemplates computer programs on an information medium, these programs being suitable to be implemented respectively in user equipment device and a base station, or more generally in a computer, these programs respectively comprising instructions adapted to implement the steps of the wireless communication methods respectively supported by a user equipment and performed by a base station disclosed herein.

These programs can use any programming language, and be in the form of source code, object code, or of code intermediate between source code and object code, such as in a partially compiled form, or in any other desirable form.

A further aspect contemplates an information medium readable by a computer comprising instructions of a computer program such as mentioned hereinabove. The information medium may be any entity or device capable of storing the program. For example, the medium can comprise a storage means, such as a ROM (Read Only Memory), for example a CD ROM or a microelectronic circuit ROM, EEPROM (Electrically Erasable Programmable Read-Only Memory), FLASH memory or any magnetic recording means, for example a hard drive.

Moreover, the information medium may be a transmissible medium such as an electrical or optical signal, which may be conveyed via an electrical or optical cable, by radio or by other means. The program according to an embodiment of the invention may be downloaded from a network.

Alternatively, the information medium may be an integrated circuit into which the program is incorporated, the circuit being arranged to execute or to be used in the execution of the methods in question.

### BRIEF DESCRIPTION OF THE DRAWINGS

Other advantages and characteristics of the invention will be more clearly apparent on reading the following description, given by way of simple illustrative and nonlimiting example, and the appended drawings.

FIG. 1 depicts AI/ML based federated learning for wireless network.

FIG. 2 shows the AI/ML model training with beam-level mobility UE.

FIG. 3 shows the duplication of local model update report.

FIG. 4 shows method steps of the base station gNB receiving duplicated local model update report from a UE device.

FIG. 5 shows method steps of the base station gNB indicating whether a UE needs to duplicate a local model update report (e.g. RRC_CONNECTED).

FIG. 6 shows method steps of the UE device receiving duplication report indication (e.g. RRC_CONNECTED).

FIG. 7 shows method steps of the UE device determining duplicated transmission of a local model update report (e.g. RRC_INACTIVE/IDLE).

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD- ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the fimctions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

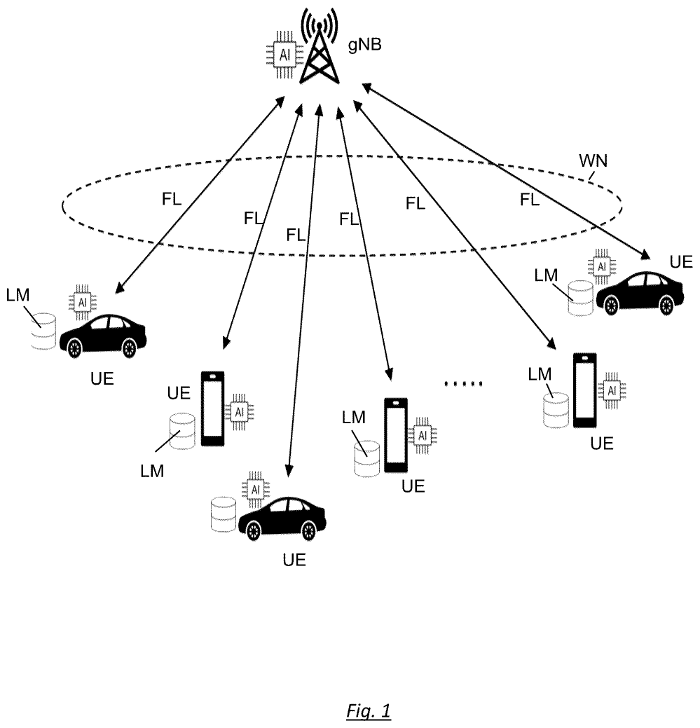

FIG. 1 shows an exemplary 5G New Radio (NR) wireless communication system comprising user equipment devices UE and a base station gNB in which aspects of the present disclosure may be practiced. The wireless network WN may be an LTE network or some other wireless network, such as LTE, 5G or NR network. The wireless network may include one or more base stations gNB. The base station gNB may be referred as BS, NB, eNodeB (or eNB), gNodeB (or gNB), an access point or the like, depending on the wireless standard implemented. Base station gNB provides radio communication coverage for a particular geographic area called “cell”.

User equipment devices UE may be referred to any device such as a mobile station, a wireless terminal, or the like. In some examples, user equipment may be a cellular phone, a wireless modem, a wireless communication device, a handheld device, a laptop computer or the like. User equipment may also be an IoT (internet of things) device, like wireless camera, a smart sensor or smart meter, a vehicle, a global positioning system device, or any other device configured to communicate through a wireless network.

The user equipment devices UE are used, e.g., for artificial intelligence/machine learning AI comprising local models LM comprised in a dataset for artificial intelligence/machine learning AI. User equipment devices UE participate in a federated learning FL in which AI/ML based local model updates are collected from multiple user equipment devices UE, and a global model on the server gNB is updated in iterative way for model training/inference.

User equipment UC may support various communication modes, such as a connected mode or state (RRC Connected), an inactive mode or state (RRC Inactive), or an idle mode or state (RRC Idle), as e.g. defined by 3GPP-Standard. When operating in RRC Connected mode, user equipment device UE is active and communicates with the base station. The user equipment device UE may transition from communication mode to another mode using various commands and messages received from the base station gNB. For example, user equipment device UE may switch from RRC Connected state to RRC Inactive state upon receiving a RRC Release message including a suspendConfig parameter.

User equipment device UE may enter RRC Inactive state without completely releasing radio resources when there is no traffic, in order to quickly switch back to RRC Connected states when necessary. In this case, user equipment and base station may store a context for the user equipment, for example an access stratum (AS) context, in order to apply said stored context when transitioning from RRC Inactive to RRC Connected state and thus reduce latency and signaling overhead. Such context may include Radio configuration parameters, such as uplink grant, RNTI (Radio Network Temporary Identifier), MCS (Modulation and Coding Scheme) and/or the like.

However, radio conditions may change while user equipment UE is in RRC Inactive state, for example user equipment may move to other locations, thus altering channel quality.

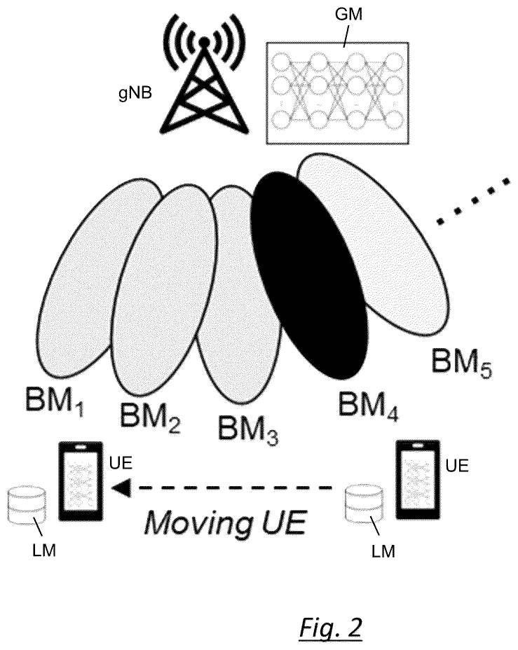

FIG. 2 shows the AI/ML global model training with beam-level mobility UE.

As mentioned and shown more in detail in FIG. 2, n AI/ML global model GM training with federated learning FL, user equipment devices UE provide local model updates to the global model based in this example in the base station gNB. In modern wireless communication networks, such as 3GPP 5G NR, data transmission occurs via directed beams BM between the base station gNB and the user equipment devices. Typically, there are several beams BM in different directions connecting to the base station gNB, denoted by indices 1 to 5 in FIG. 2.

The user equipment devices UE can move away from the determined beam direction (BM4 in the shown example) with beam-level mobility or can be located at beam-edge, and those equipment devices UE can then be missed out due to poor link quality with the outdated beam direction. Without managing those user equipment devices UE carefully, the overall global model operation can be impacted with divergent performance by losing them for model training.

During a preliminary step, user equipment device UE may switch to a RRC Inactive state in response to a RRC Release message with suspendConfig parameter. An I-RNTI (Inactive Radio Network Temporary Identifier) may be allocated to user equipment device UE within such RRC Release message as part of a suspendConfig parameter.

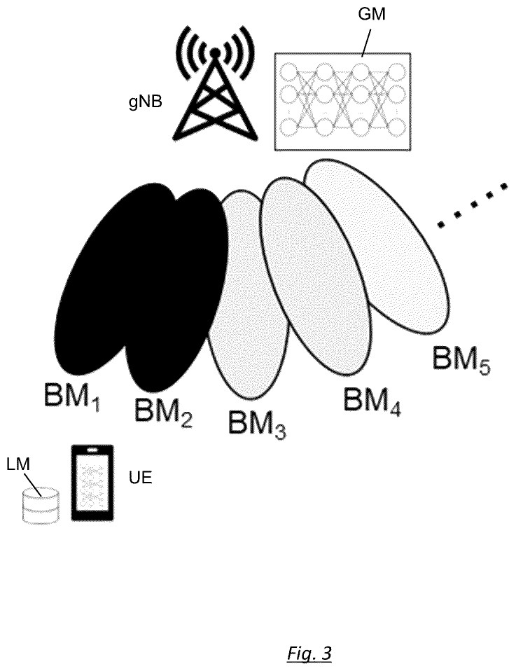

In line with the proposal and as shown in FIG. 3, a duplication of local model update report is proposed whereby each local model update report for user equipment devices UE having poor channel quality in beam-level mobility or beam-edge region is duplicated and transmitted at different time interval over different frequency resources, i.e. the different beams BM1 und BM2.

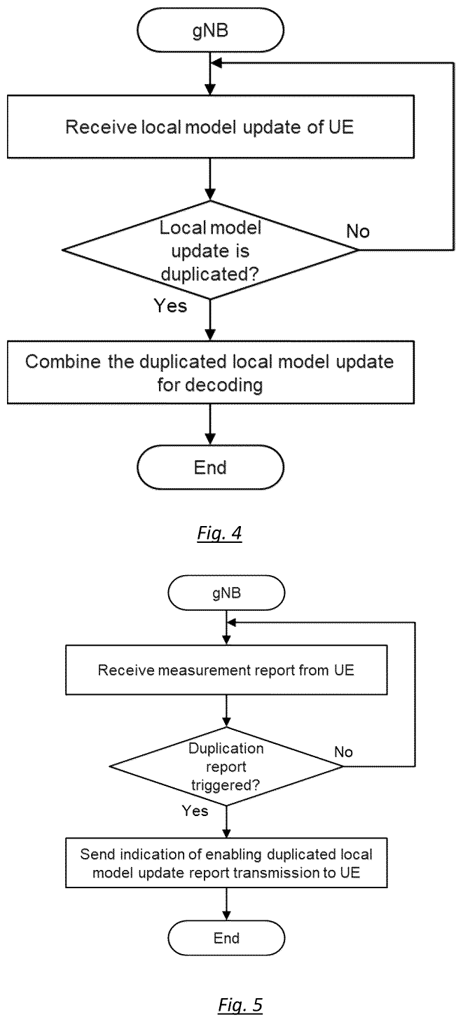

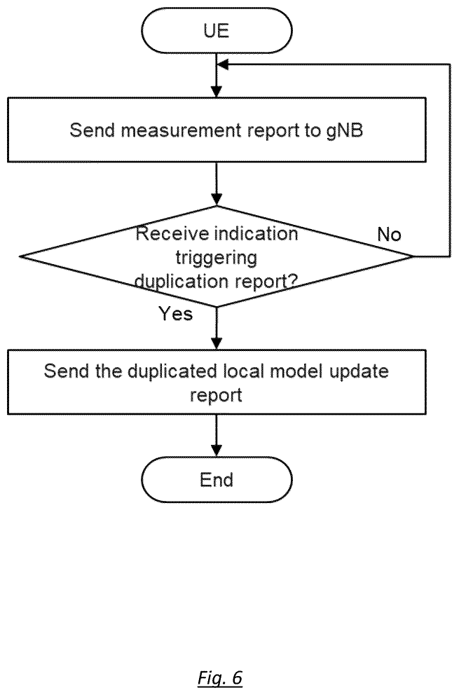

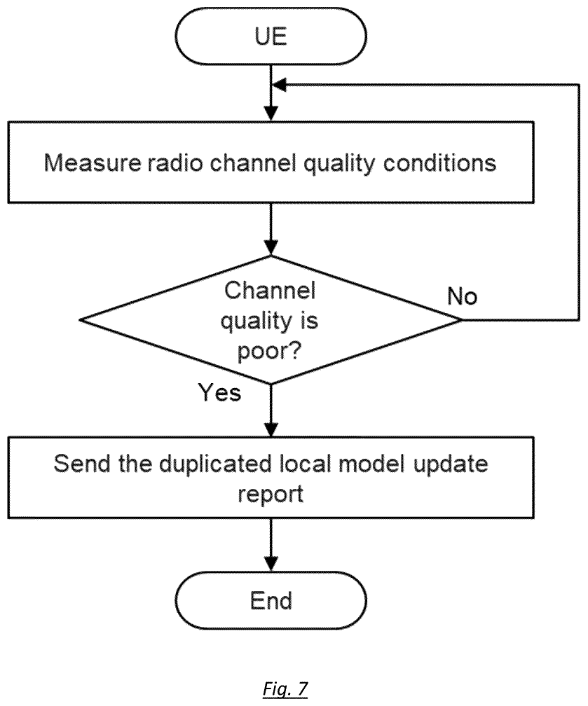

FIGS. 4 to 7 show different method steps performed by the base stations gNB and/or the users equipment devices UE. More in detail, FIG. 4 shows a base station gNB receiving a duplicated local model update report from a user equipment device UE, FIG. 5 shows a base station gNB indicating whether a user equipment device UE needs duplicate local model update report (e.g. RRC_CONNECTED), FIG. 6 shows a user equipment device UE receiving duplication report indication (e.g. RRC_CONNECTED), and FIG. 7 shows a user equipment device UE of determining duplicated transmission of local model update report (e.g. RRC_INACTIVE/IDLE).

The user equipment device UE (apparatus) comprises a processor and a memory, for example a Random Access Memory (RAM). The processor may be controlled by a computer program stored in the memory comprising instructions configured to implement a method for receiving Data Transmission from a base station gNB in a wireless communication network WN.

More precisely, the computer program comprises instructions for receiving a paging notification from a base station gNB while in inactive state, the paging notification comprising at least an indication that downlink small data is available for transmission, and a priority flag associated with said downlink small data, to determine at least a Synchronization Signal Reference Signal Received Power, and to postpone downlink data reception until next paging cycle when said priority flag indicates low priority downlink data and said at least a Synchronization Signal Reference Signal Received Power is below a threshold.

On initialization, instructions of the computer program may be loaded into the memory before being executed by the processor. The processor implements the steps of the method according to the instructions of the computer program.

The user equipment device UE comprises a wireless communication unit, for example a 3G, 4G, 5G, 5G NR, WiFi or WiMax transceiver for exchanging messages with other apparatus.

The user equipment device UE further comprises a channel quality sensor. The channel quality sensor may be configured by computer program instructions to measure the signal strength on one or more available SSBs (Synchronization Signal Blocks), and to compare the measured values to a preconfigured threshold to determine whether all SSB's RSRP are below said threshold value.

According to an embodiment, the user equipment device UE further comprises a scheduler unit. The scheduler unit may be configured by computer program instructions to postpone downlink data reception until next paging cycle when said priority flag received by communication unit indicates low priority downlink data and when the channel quality sensor determines that said measured all SSB's RSRP are below said threshold.

In some embodiments, the user equipment device UE may comprise a random access module configured by computer program instructions to initiate a Random Access Procedure. The Random Access Procedure may include the sending through the communication unit of a quality indicator determined by the channel quality sensor to the serving base station. In some examples, the quality indicator is sent as a binary flag, which is set to indicate that all SSB's RSRP are below a preconfigured threshold (CQI-measure).

According to an embodiment, the communication unit is further configured by computer program instructions to receive downlink data from the base station, said downlink data being transmitted using a low modulation scheme selected by said base station based on said at least a Synchronization Signal Reference Signal Received Power being below a threshold.

In some embodiments, the user equipment device UE is included in a smartphone, a laptop, an IoT (Internet of Things) device or a vehicle.

In this communication context, and in case that federated learning FL based global model aggregation requires high timeliness, then the proposed duplicated transmission can also consider the below method steps and variants:.

If the base station gNB knows that the communication quality is bad based on a measurement, then it can configure CG resources in contiguous slot. So, the user equipment device UE can send the local model update report through repetition manner (back to back continues slots), or the base station gNB can configure periodicity of CG resources in a dense manner to avoid any latency issue (applicable to RRC connected as well as inactive mode).

According to specific embodiments of the inventions, and as described below, the user equipment device UE can measure the radio quality conditions based on a CQI-measure (FIG. 7), e.g. on a regular time basis. If it turns out (in comparison to defined thresholds) that the channel quality is not poor, i.e. good enough for regular data transmission, no further measure is taken, and the channel quality measurement is repeated later, e.g. after the transmission of the next coming user equipment report transmission.

If channel quality, however, is poor, the user equipment device UE sends a duplicated local model update report (user equipment report transmission) to the base station gNB, as indicated in FIG. 3.

In line with the duplication or the local model update, the base station gNB, after receipt of a user equipment report transmission (local model update), the base station gNB determines whether the transmission was related to a duplicated local model update (FIG. 4). If not, the base station gNB awaits receipt of a new (next) local model update from an user equipment device UE. If yes, the base station gNB combined the duplicated local model update for decoding.

In a further aspect, shown in FIG. 5, the user equipment device UE transmits, after determining the radio channel quality conditions of the used beam or cell based on a CQI-measure, a (channel quality) measurement report to the base station gNB, and the base station gNB, after receiving this measurement report, assess the radio channel quality conditions and triggers whether the user equipment device UE shall send a duplicated user equipment (UE) report transmission. If so, the base station gNB may send in line with the proposal an indication of enabling duplicated local model update report transmissions to the user equipment device UE (FIG. 6).

In this context, it may be provided that the base station gNB configures the threshold to determine whether duplicated local model update report transmission is needed. Threshold is, for example, configured through system information message for SSB and RRC reconfiguration message for CSI-RS.

The user equipment device UE sends such duplication of local model update report in time-frequency domain, wherein the base station gNB may configure the time-frequency resources in dedicated manner (with RRC reconfiguration message)/system information (e.g. CG) for duplication report transmission.

Then, or depending on RRC mode (connected or inactive/idle), the UE decides to duplicate local model update transmission when the current channel quality is poor based on the threshold configured by the base station gNB.

In this context, the base station gNB may configure CG periodicity very short to avoid any latency issue, if necessary. This enables a quasi-continuous transmission of update reports.

Further, the base station gNB may determine a local model update reporting channel use by considering both PUCCH and PUSCH depending on local model update report size.

Based on the proposed duplicated transmission method for mobile user equipment devices UE with beam-level mobility, AI/ML performance for wireless communication can be greatly improved.

The cited approaches of all embodiments can be combined together with all the others disclosed accordingly.

This feature is most beneficial for sensors, IoT devices, and even messaging and presence applications in smartphones or vehicles, in particular as fast moving user equipment devices.

1. A method of duplicated user equipment report transmission by a user equipment device connected to a wireless communication network, wherein the user equipment device determines radio channel quality conditions of the used beam or cell based on a CQI-measure and sends, if poor channel quality is determined, a duplication of a local model update report in a time-frequency domain, wherein a base station configures time-frequency resources in dedicated manner with RRC reconfiguration message and/or system information.

2. The method according to claim 1, wherein the method is characterized by determining in the user equipment device the radio channel quality conditions based on a threshold configured by the base station, wherein said threshold is configured through a system information message for synchronization and RRC reconfiguration message for channel state information.

3. The method according to claim 1, wherein a decision is made by the user equipment device to duplicate a local model update transmission when the current channel quality is poor.

4. The method according to claim 1, wherein a CG periodicity is configured very short to avoid any latency issue.

5. The method according to claim 1, wherein, for local model update reporting as a channel, a PUCCH-channel of the wireless communication network is used, if number of payload bits in local update report is small, and a PUSCH-channel of the wireless communication network is used, if local model update information could be large and part of RRC signaling, wherein the PUCCH-channel is a physical uplink control channel that carries uplink control information and may be combined with moderate payload data and the PUSCH-channel is a physical uplink shared channel that carries user data and can be combined with uplink control information.

6. An apparatus of duplicated UE report transmission in a wireless communication network directed to a base station, the apparatus comprising a wireless transceiver, a processor coupled with a memory in which computer program instructions are stored, said computer program instructions being configured to perform operations comprising: the user equipment device determines radio channel quality conditions of the used beam or cell based on a COI-measure and sends, if poor channel quality is determined, a duplication of a local model update report in a time-frequency domain, wherein the base station configures time-frequency resources in dedicated manner with RRC reconfiguration message and/or system information.

7. The apparatus according to claim 6, wherein the apparatus is a user equipment device.

8. A method of duplicated UE report transmission, by a user equipment device connected to a wireless communication network, for receipt of the UE report transmission by a base station in the wireless communication network, wherein the user equipment device determines radio channel quality conditions of the used beam or cell based on a CQI-measure and sends, if poor channel quality is determined, a duplication of a local model update report in a time-frequency domain, wherein time-frequency resources of the wireless transmission are configured in dedicated manner with an RRC reconfiguration message and/or system information by the base station.

9. An apparatus of duplicated UE report transmission in a wireless communication network, the apparatus comprising a wireless transceiver, a processor coupled with a non-transitory memory in which computer program instructions are stored, said instructions being configured to transmit duplicated UE report, by a user equipment device connected to the wireless communication network, for receipt of the UE report transmission by a base station in the wireless communication network, by performing operations comprising:
the user equipment device determines radio channel quality conditions of a used beam or cell based on a CQI-measure and sends, if poor channel quality is determined, a duplication of a local model update report in a time-frequency domain, wherein time-frequency resources of the wireless transmission are configured in dedicated manner with an RRC reconfiguration message and/or system information by the base station.

10. The apparatus according to claim 9, wherein the apparatus is a base station.

11. A wireless communication system for duplicated UE report transmission from a user equipment device to a base station,
wherein the base station comprises a base-station processor coupled with a base-station memory in which base-station computer program instructions are stored, said base-station computer program instructions being configured to perform operations comprising: time-frequency resources of the wireless transmission are configured in dedicated manner with an RRC reconfiguration message and/or system information by the base station, wherein the user equipment device comprises a user-equipment processor coupled with a user-equipment memory in which user-equipment computer program instructions are stored, said user-equipment computer program instructions being configured to perform operations comprising: the user equipment device determines radio channel quality conditions of the used beam or cell based on a CQI-measure and sends, if poor channel quality is determined, a duplication of a local model update report in a time-frequency domain.
